(19) United States
(12) Patent Application Publication
(10) Pub. No.: US 2010/0316796 A1
(43) Pub. Date: Dec. 16, 2010

(54) METHOD FOR PRODUCING RAISED MARKING ON A GLASS OBJECT

(75) Inventors: Juergen Weber, Kleinostheim (DE); Norbert Traeger, Maintal (DE); Thilo Braemer, Bruchkoebel (DE); Waltraud Werdecker, Hanau am Main (DE); Maximilian Kara, Erlenbach (DE)

Correspondence Address: TIAJOLOFF & KELLY, CHRYSLER BUILDING, 37TH FLOOR, 405 LEXINGTON AVENUE, NEW YORK, NY, 10174, US

(73) Assignee: HERAEUS QUARZGLAS GMBH & CO. KG, Hanau (DE)

(21) Appl. No.: 12/792,699

(22) Filed: Jun. 2, 2010

(30) Foreign Application Priority Data
Dec. 3, 2007 (DE) 10 2007 058 360.7

(51) Int. Cl. B05D 3/02

(52) U.S. Cl. 427/193; 977/902

(57) ABSTRACT

In a known method for producing a raised marking on a glass object, a suspension containing SiO₂ particles is applied to a surface of the glass object as a pattern, and the pattern is compacted to form the marking. Starting from this, in order to enable a cost-effective production of an optically appealing and uniform marking on an object made of quartz glass, which marking is also suited for applications at high temperature or in a contamination-sensitive environment, such as in solar cell and semiconductor production, it is suggested according to the invention that a binder-free suspension be used to create a marking on a quartz glass object, the suspension containing a dispersion liquid and amorphous SiO₂ particles having particle sizes of up to a maximum of 500 μm, of which are between 0.2% by wt. and 15% by wt. SiO₂ nanoparticles having particle sizes of less than 100 nm, and the solids content thereof, i.e. the weight proportion of the SiO₂ particles and of the SiO₂ nanoparticles together, is in the range between 60% and 90%.

The present invention relates to a method for producing a raised marking on a glass object in that a suspension containing SiO₂ particles is applied to a surface of the glass object as a pattern, and the pattern is compacted to form the marking.

### PRIOR ART

The application of a layer to a glass object for decorating and marking purposes is generally known. Baking enamels that are applied by means of a screen printing process are here often used. Methods in which the pattern is transferred by means of a flat carrier material to the glass surface and is subsequently fired are also common. The surface layers produced in this way are thin and not suited for producing elevated or raised structures.

A method of the aforementioned type is known from DE 1 596 666 A. It is suggested for the production of a glass sheet with a raised pattern that a suspension of a quartz powder and a binder should be applied to the sheet surface in stripes, and the stripes produced should subsequently be fused at a temperature of 630° C. Pine oil and sodium silicate are used as the binder.

The binder contains substances that, when the glass object is used at high temperature or in a contamination-sensitive environment, cause unacceptable changes in the glass object itself or in the materials surrounding the object. Components of quartz glass are often used for such applications, e.g. in semiconductor production. The known marking method would here lead to a devitrification at high temperature or to a change in the electrical properties of a neighboring semiconductor material due to contamination by sodium.

Therefore, markings, such as serial numbers, have so far been produced on components of quartz glass for use at high temperature in that a quartz glass strand is manually placed on the surface in the form of the marking and successively welded. Such a procedure is however time-consuming and not suited for markings with uniform appearance.

In the method known from DE 100 09 185 A1 for producing a relief decoration on a substrate, relief-forming moldings of glass frit and color pigments are produced, placed on the substrate surface and fixed by ceramic firing.

EP 1 614 664 A1 describes a method for coloring a relief glass. Here, on a glass substrate, glass frit and a color pigment of a higher firing temperature than glass frit and glass substrate are applied by means of a printing technique. Upon softening of the glass substrate in a relief type melting mold the color pigment is fixed.

DE 10 2005 058 819 A1 discloses a method for producing a reflecting coating on a quartz glass component in that a quartz glass nonwoven impregnated with a SiO₂ containing slurry is placed on the component surface, dried and vitrified. The SiO₂ particles of the slurry used therefor have a particle size distribution with a D₅₀ value of around 8 μm and a D₉₀ value of around 40 μm.

### TECHNICAL OBJECT

It is therefore the object of the present invention to provide a method enabling a cost-effective production of an optically appealing and uniform marking on an object made of quartz glass, the marking being also suited for applications at high temperature or in a contamination-sensitive environment, such as in semiconductor production.

Starting from a method of the aforementioned type, this object is achieved according to the invention in that a binder-free suspension is used to create a marking on a quartz glass object, said suspension containing a dispersion liquid and amorphous SiO₂ particles having particle sizes of up to a maximum of 500 μm, of which are between 0.2% by wt. and 15% by wt. SiO₂ nanoparticles having particle sizes of less than 100 nm, and the solids content thereof, i.e. the weight proportion of the SiO₂ particles and of the SiO₂ nanoparticles together, is in the range between 60% and 90%.

In the method according to the invention a suspension is used for producing the pattern, the suspension being free of binders. Constituents of conventional binders, such as alkali or alkaline-earth compounds, which may cause a reduction of the viscosity of quartz glass and a devitrification of the quartz glass object, are thereby avoided.

The solids content (that is the weight proportion of the SiO₂ particles and the SiO₂ nanoparticles together) of the suspension is relatively high at a value between 60% and 90%. The high solids content effects a high “green body density” of the applied pattern, thereby contributing to a uniform and insignificant shrinkage of the layer applied, whereby the risk of drying or sintering cracks is reduced.

On the other hand, such highly filled SiO₂-containing suspensions are very viscous as a rule and typically show a dilatant-rheopexic flow behavior. This means that upon mechanical action (such as stirring, shaking, filling, dispersion coating, stripping, spreading by doctor blade, spraying) the suspension exhibits increased viscosity (dilatancy) or that after mechanical impact the viscosity is increased for a short period of time (rheopexy).

This flow behavior, however, turns out to be disadvantageous when the suspension is to be applied to the surface of the quartz glass object by spraying or dispersion coating (also: stripping, troweling, dressing, scraping, filling). A highly viscous suspension is not suited for these application techniques as it solidifies under the action of the distributing force, thereby counteracting the uniform distribution thereof. In the inactive condition it can however become liquid again, so that the pattern lines applied to the surface expand and get blurred.

It has been found that the flow behavior of a dilatant-rheopexic suspension is changed by the addition of a small amount of SiO₂ nanoparticles to show a rather structurally viscous thixotropic behavior. “Thixotropy” of a suspension manifests itself in that with a constant shear stress (for instance at a constant stirring rate) its viscosity is continuously decreasing for some time. Related therewith is “structural viscosity” in the case of which the viscosity is also reduced due to shear, but which is not further decreasing at a constant shear stress.

According to the invention the suspension therefore contains between 0.2% by wt. and 15% by wt. of SiO₂ nanoparticles with particle sizes of less than 100 nm. SiO₂ nanoparticles are here understood to be SiO₂ particles having particle sizes in the range of a few nanometers of up to 100 nm, preferably below 50 nm. Such nanoparticles have a specific BET surface area of 40-800 m²/g, preferably between 55 m²/g and 200 m²/g. The SiO₂ nanoparticles can e.g. be prepared by oxidation or hydrolysis of silicon-containing start compounds (hereinafter also called “pyrogenic silica”) or by polycondensation of polymerizable silicon compounds (SiO₂ sol).

The SiO₂ nanoparticles cause interactions between the amorphous SiO₂ particles of the suspension on the whole and effect the formation of physical or chemical bonds between the amorphous SiO₂ particles among one another. Upon occurrence of shear forces these interactions are diminishing, resulting in a “liquefaction” of the suspension. After omission of the shear forces, in the passive state of the suspension mass, these interactions will augment again, thereby stabilizing the inactive suspension mass.

The known application techniques are suited for applying the suspension, especially also the removal from a carrier on which an image of the pattern is present (decal), a suspension with a particularly high solids content being here preferred. However, a method variant is particularly preferred in which the suspension is applied by spraying or dispersion coating.

Due to its structurally viscous thixotropic flow behavior the suspension used in the method according to the invention liquefies under shear stress. This property is conducive to a uniform outflow and to the distribution of the suspension mass over the surface under action of a force with a distributing effect, such as during dispersion coating or spraying, and ensures, on the other hand, a rapid stabilization of the suspension applied in areas and lines of the pattern to be produced.

In the case of very high solids contents of more than 90%, the workability of the suspension by way of spraying or dispersion coating is however decreasing considerably although the suspension is mixed with SiO₂ nanoparticles. At a content of less than 0.2% by wt. the nanoparticles have no significant effect on the flow behavior of the suspension, whereas contents of more than 15% by wt. may lead to an increased shrinkage of the pattern during drying. In the case of very thin layers (<0.1 mm) a higher content of SiO₂ nanoparticles can be used because thin layers are less prone to shrinkage cracks than thick layers.

In this respect it has turned out to be particularly advantageous when the suspension contains SiO₂ nanoparticles between 0.5% by wt. and 5% by wt., preferably between 1% by wt. and 3% by wt. (based on the total solids content).

In a preferred method variant, the marking consists of similar or specific material with respect to the quartz glass object.

“Similar material” means in the present context that the SiO₂ contents of marking and quartz glass object differ by not more than 3% by wt. from one another. This accomplishes a very good adhesion of the marking on the object and ensures a high thermal shock resistance of the composite.

Depending on the requirements, the marking is opaque, translucent or fully transparent. With an appropriate temperature control the risk of crack formation during compaction of the pattern can be reduced. Compaction is carried out by way of sintering (e.g. in a furnace) or by vitrification (e.g. by means of a flame). In a first preferred method variant, the dried pattern is compacted at a comparatively low maximum temperature in the range between 1100° C. and 1600° C., preferably below 1450° C.

During compaction the low maximum temperature prevents a rapid compaction of the outer surface areas of the pattern. Such a compaction would impede the further progress of a vitrification front due to its heat-insulating effect, thereby rendering a complete compaction of thicker layers more difficult. As a rule, one obtains an opaque or translucent or diaphanous marking in this process.

As an alternative, compaction of the pattern is carried out at a temperature above 1600° C.

As a rule, this yields a marking of transparent quartz glass.

It has turned out to be useful when the suspension is applied by means of a mask that is placed on the surface and predetermines the pattern.

The mask helps to observe a uniform appearance of the pattern to be produced.

The thickness of the marking may be up to 1 mm. In contrast to the above-described conventional method, the method according to the invention also facilitates the manufacture of particularly thin marking layers, preferably with layer thicknesses in the range between 0.1 mm and 0.5 mm.

It has turned out to be useful when for the production of the marking a suspension is used in which SiO₂ particles with particle sizes in the range between 1 μm and 60 μm account for the largest volume fraction, with the SiO₂ particles showing a multimodal particle size distribution with a first maximum of the size distribution in the range of 1 μm to 5 μm and a second maximum in the range of 5 μm to 50 μm.

The amorphous SiO₂ particles show a multimodal particle size distribution having at least two, preferably three or more, distribution maxima. This helps to set a high solids density in the suspension, whereby shrinkage during drying and compaction and thus the risk of crack formation are further reduced.

A particularly advantageous compromise between a pattern showing a low tendency to form cracks on the one hand and an easy processing of the suspension by spraying and dispersion coating on the other hand is achieved when the suspension has a solids content in the range between 70% by wt. and 80% by wt. Particularly preferably, the solids content is at least 75% by wt.

It has turned out to be particularly advantageous when at least 80% by wt., preferably at least 90% by wt., of the SiO₂ particles are made spherical.

Spherical particles help to set a high solids density in the slurry, so that stresses during drying and compaction are reduced. Ideally, all of the SiO₂ particles are made spherical.

Preferably, the SiO₂ particles have a particle size distribution that is distinguished by a D₅₀ value of less than 50 μm, preferably of less than 40 μm.

SiO₂ particles in this order exhibit advantageous sintering and vitrification properties and comparatively low shrinkage during drying, so that a corresponding pattern can be dried and compacted particularly easily without the formation of cracks.

The dispersion liquid may consist of an aqueous base. The polar nature of the aqueous phase of such a suspension may have an impact on the interaction of the SiO₂ particles. For the suspension according to the invention a dispersion liquid is however used in the form of a mixture consisting of water and an inorganic solvent, preferably based on alcohol.

The aqueous proportion in the dispersion liquid helps to observe a thixotropic flow behavior and to set a desired viscosity. The alcohol amount of the dispersion liquid accelerates drying, as compared with an aqueous dispersion. This saves time and leads to a faster fixing of the pattern on the surface of the quartz glass object, so that bleeding on the edges of the pattern is reduced. The viscosity of the suspension on the one hand and its drying behavior on the other hand can thus be optimized by setting the amounts of water and inorganic solvent (alcohol).

Preferably, the SiO₂ particles consist of naturally occurring SiO₂ raw material and the SiO₂ nanoparticles of synthetic SiO₂.

Naturally occurring SiO₂ raw material is comparatively inexpensive and is distinguished by high viscosity. Synthetic SiO₂ is distinguished by high purity.

It has turned out to be advantageous when the SiO₂ content of the amorphous SiO₂ particles is preferably at least 99.9% by wt.

The solids proportion of the suspension produced by using such particles consists of at least 99.9% by wt. of SiO₂ (apart from added dopants, e.g. for coloring the marking). Binders or other additives are not needed and are not contained in an ideal case. The marking of “similar material” exhibits a particularly high thermal shock resistance.

### Embodiment

The invention shall now be explained in more detail with reference to embodiments and a drawing, which shows in detail in:

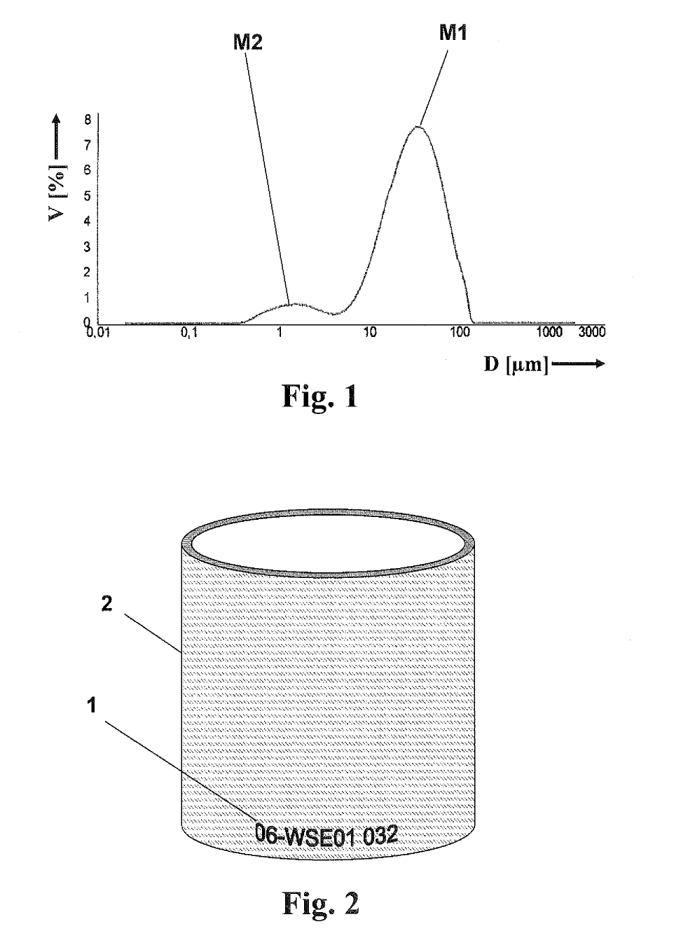

FIG. 1 a diagram of the SiO₂ particle size distribution of a raw material component suited for the preparation of a suspension for performing the method according to the invention (prior to the addition of SiO₂ nanoparticles); and

FIG. 2 a quartz glass tube for use as a reactor in solar cell production, which tube is provided with an identification in the form of a raised marking.

The diagram of FIG. 1 shows a particle size distribution of a quartz glass powder, with a first maximum M1 of the size distribution at about 30 μm (D₅₀ value) and with a second smaller maximum M2 around 2 μm. The quartz glass powder (with a D₅₀ value at 30 μm) shall be called R₃₀ hereinafter.

For preparing a suspension for producing a marking, further quartz glass powders are used having D₅₀ values at 5 μm, 15 μm and 40 μm and having particle size distributions otherwise similar to those shown in FIG. 1. Said quartz glass powders are called R₅, R₁₅, or R₄₀, depending on their D₅₀ value.

The quartz glass powders R₃₀, R₁₅ and R₅ are dispersed and homogenized in the quantitative amounts 500 g; 200 g; 200 g (in the sequence of their naming) in a mixture consisting of 70 parts by weight of ethanol and 30 parts by weight of ultrapure water. 135 g of pyrogenic silica in the form of SiO₂ nanoparticles with diameters of around 40 nm with a specific BET surface area of 50 m²/g are added to the homogenized slurry, resulting in a suspension with a solids content of 75% by wt.

The particle sizes below 60 μm account for the largest volume fraction of the solid. The suspension that is exclusively prepared with synthetically produced spherical SiO₂ particles of high purity is free of crystalline constituents (cristobalite, quartz) and is distinguished by a low contamination content of less than 1 wt. ppm. The binder-free suspension shows thixotropic behavior and is excellently suited for processing techniques such as spraying or dispersion coating.

FIG. 2 schematically shows a raised marking 1, produced by using the suspension, in the form of a serial number on the outer jacket of a quartz glass tube 2. The quartz glass tube 2 is intended for use as a reactor in solar cell production (photovoltaics). The marking is produced in that a sheet, from which the serial number has been punched out, is placed on the outer jacket surface. The above-described SiO₂ suspension will be sprayed onto this mask with the help of a standard spray bottle until a uniform layer thickness has been achieved that approximately corresponds to the sheet thickness (0.2 mm).

After a pre-drying process in air for 10 minutes the sheet is removed, whereby a pattern consisting of porous SiO₂ (green body layer) is exposed in the form of the serial number. The green body layer is dried in air for another six hours. The drying process is completed by use of an IR radiator. The dried green body layer is without cracks and has a mean thickness of about 0.17 mm. It is subsequently vitrified by means of an oxyhydrogen burner at a temperature of about 1500° C. to obtain the fully transparent marking 1.

Raised markings of uniform appearance can thereby be produced in a reproducible manner on quartz glass components.

1. A method for producing a raised marking on a glass object, said method comprising:
applying a suspension containing SiO₂ particles to a surface of the glass object as a pattern;
compacting the pattern to form the marking;
wherein the suspension used to create the marking on the quartz glass object is a binder-free suspension, said suspension containing a dispersion liquid and amorphous SiO₂ particles having particle sizes of up to a maximum of 500 μm, wherein said SiO₂ particles comprise between 0.2% by wt. and 15% by wt. SiO₂ nanoparticles having particle sizes of less than 100 nm, and the suspension has a solids content with a weight proportion of the SiO₂ particles that, is in a range between 60% and 90%.

2. The method according to claim 1, wherein the suspension is applied by spraying or dispersion coating.

3. The method according to claim 1, wherein the SiO₂ nanoparticles are present in a range between 0.5% by wt. and 5% by wt. based on a total solids content of the suspension.

4. The method according to claim 1, wherein the marking is of similar material with respect to the quartz glass object.

5. The method according to claim 1, wherein the pattern is compacted at a temperature ranging between 1100° C. and 1600° C.

6. The method according to any one of claim 1, wherein the pattern is compacted at a temperature above 1600° C.

7. The method according to claim 1, wherein the suspension is applied via a mask that predetermines the pattern and is placed on the surface.

8. The method according to claim 1, wherein a marking is produced with a layer thickness between 0.1 mm and 0.5 mm.

9. The method according to claim 1, wherein SiO₂ particles with particle sizes in a range between 1 μm and 60 μm account for the greatest volume fraction, the SiO₂ particles having a multimodal particle size distribution with a first maximum of the size distribution in a range of 1 μm to 5 μm and with a second maximum in a range of 5 μm to 50 μm.

10. The method according to claim 1, wherein the suspension has a solids content in a range between 70% by wt. and 80% by wt.

11. The method according to claim 1, wherein at least 80% by wt. of the SiO₂ particles are spherical.

12. The method according to claim 1, wherein the SiO₂ particles have a particle size distribution that has a D₅₀ value of less than 50 μm.

13. The method according to claim 1, wherein the dispersion liquid comprises a mixture of water and an organic solvent.

14. The method according to claim 1, wherein the SiO₂ particles consist of naturally occurring raw material and the SiO₂ nanoparticles consist of synthetic SiO₂.

15. The method according to claim 1, wherein the SiO₂ content of the amorphous SiO₂ particles is at least 99.9% by wt.

16. The method according to claim 1, wherein the SiO₂ nanoparticles are present in a range between 1% by wt. and 3% by wt. based on a total solids content of the suspension.

17. The method according to claim 1, wherein the pattern is compacted at a temperature below 1450° C.

18. The method according to claim 1, wherein at least 90% by wt. of the SiO₂ particles are spherical.

19. The method according to claim 1, wherein the SiO₂ particles have a particle size distribution that has a D₅₀ value of less than 40 μm.

20. The method according to claim 1, wherein the dispersion liquid comprises a mixture of water and an organic solvent based on an alcohol.
